(19) United States
(12) Patent Application Publication
(10) Pub. No.: US 2014/0309096 A1
(43) Pub. Date: Oct. 16, 2014

(54) Biological Fluid Collection Device and Biological Fluid Separation System

(71) Applicant: Becton, Dickinson and Company, Franklin Lakes, NJ (US)

(72) Inventors: Bradley M. Wilkinson, North Haledon, NJ (US); Craig A. Gelfand, Jackson, NJ (US)

(21) Appl. No.: 14/251,697

(22) Filed: Apr. 14, 2014

Related U.S. Application Data
(60) Provisional application No. 61/811,918, filed on Apr. 15, 2013.

(51) Int. Cl. B01L 3/00; G01N 1/40; B04B 7/08

(52) U.S. Cl. CPC B01L 3/5021; B04B 7/08; G01N 1/4077
USPC 494/43; 422/548; 422/533

(57) ABSTRACT

A biological fluid separation system for a blood sample is disclosed. The biological fluid separation system includes a biological fluid collection device adapted to receive a blood sample and a centrifuge. The centrifuge is adapted to receive the biological fluid collection device such that with the biological fluid collection device received within the centrifuge and a rotational force applied to the biological fluid collection device, a plasma portion of the blood sample is separated from a cellular portion of the blood sample. The biological fluid collection device is only receivable within the centrifuge in one orientation.

### CROSS-REFERENCE TO RELATED APPLICATION

The present application claims priority to U.S. Provisional Application No. 61/811,918, filed Apr. 15, 2013, entitled “Medical Device for Collection of a Biological Sample”, the entire disclosure of which is hereby incorporated by reference.

### BACKGROUND OF THE INVENTION

1. Field of the Disclosure

The present disclosure relates generally to devices, assemblies, and systems adapted for use with vascular access devices. More particularly, the present disclosure relates to devices, assemblies, and systems adapted for collecting biological samples.

2. Description of the Related Art

Blood sampling is a common health care procedure involving the withdrawal of at least a drop of blood from a patient. Blood samples are commonly taken from hospitalized, homecare, and emergency room patients either by finger stick, heel stick, or venipuncture. Blood samples may also be taken from patients by venous or arterial lines. Once collected, blood samples may be analyzed to obtain medically useful information including chemical composition, hematology, or coagulation, for example.

Blood tests determine the physiological and biochemical states of the patient, such as disease, mineral content, drug effectiveness, and organ function. Blood tests may be performed in a clinical laboratory or at the point-of-care near the patient. One example of point-of-care blood testing is the routine testing of a patient's blood glucose levels which involves the extraction of blood via a finger stick and the mechanical collection of blood into a diagnostic cartridge. Thereafter, the diagnostic cartridge analyzes the blood sample and provides the clinician a reading of the patient's blood glucose level. Other devices are available which analyze blood gas electrolyte levels, lithium levels, and ionized calcium levels. Some other point-of-care devices identify markers for acute coronary syndrome (ACS) and deep vein thrombosis/pulmonary embolism (DVT/PE).

Despite the rapid advancement in point-of-care testing and diagnostics, blood sampling techniques have remained relatively unchanged. Blood samples are frequently drawn using hypodermic needles or vacuum tubes attached to a proximal end of a needle or a catheter assembly. In some instances, clinicians collect blood from a catheter assembly using a needle and syringe that is inserted into the catheter to withdraw blood from a patient through the inserted catheter. These procedures utilize needles and vacuum tubes as intermediate devices from which the collected blood sample is typically withdrawn prior to testing. These processes are thus device intensive, utilizing multiple devices in the process of obtaining, preparing, and testing blood samples. Each additional device increases the time and cost of the testing process.

Point-of-care testing devices allow for a blood sample to be tested without needing to send the blood sample to a lab for analysis. Thus, it is desirable to create a device that provides an easy, safe, reproducible, and accurate process with a point-of-care testing system.

### SUMMARY OF THE INVENTION

The present disclosure provides a biological fluid separation system, such as a blood separation system, for a blood sample. The biological fluid separation system includes a biological fluid collection device, such as a blood collection device, adapted to receive a blood sample and a centrifuge. The centrifuge is adapted to receive the biological fluid collection device such that with the biological fluid collection device received within the centrifuge and a rotational force applied to the biological fluid collection device, a plasma portion of the blood sample is separated from a cellular portion of the blood sample. The biological fluid collection device is only receivable within the centrifuge in one orientation.

Some of the advantages of the biological fluid collection device and the biological fluid separation system of the present disclosure over prior systems are that it is a closed system which reduces blood sample exposure and it provides passive and fast mixing of the blood sample with a sample stabilizer. Also, a blood sampling transfer device of the present disclosure incorporates the concepts of lancing, blood collection, and blood separation.

In accordance with an embodiment of the present invention, a biological fluid collection device includes a housing having an inlet port and a serpentine flow channel in fluid communication with the inlet port. The device also includes a puncturing element disposed within the housing which is adapted for movement between a pre-actuated position, wherein the puncturing element is retained within the housing, and a puncturing position, wherein the puncturing element extends through the inlet port of the housing and establishes flow communication with the serpentine flow channel.

In certain configurations, when the puncturing element is in the puncturing position, the biological fluid collection device is adapted to generate a vacuum in communication with the inlet port. The device may also include a second flow channel in fluid communication with the serpentine channel, with the second flow channel oriented in a plane that is offset from a plane defining a flow axis of the serpentine channel. The biological fluid collection device may also be adapted to receive a multi-component blood sample having a cellular portion and a plasma portion. When rotational force is applied to the biological fluid collection device, the plasma portion may be separated from the cellular portion through the flow channel.

In certain configurations, the device also includes an indicator element which is transitionable between an initial setting and a complete setting. The indicator element may automatically transition to the complete setting when collection of the blood sample is complete. Optionally, the puncturing element is a micro-needle array. The housing may also include a push button and actuation of the push button may move the puncturing element from the pre-actuated position to the puncturing position. In certain configurations, at least a portion of the serpentine flow channel includes a sample stabilizer. The housing may also include an electric contact for engagement with a corresponding electric contact of a centrifuge.

In accordance with another embodiment of the present invention, a biological fluid separation system for a blood sample having a cellular portion and a plasma portion includes a biological fluid collection device adapted to receive the blood sample. The blood collection device includes a housing having an inlet port and a flow channel in fluid communication with the inlet port, and a puncturing element disposed within the housing. The puncturing element is adapted for movement between a pre-actuated position, wherein the puncturing element is retained within the housing, and a puncturing position, wherein the puncturing element extends through the inlet port of the housing and establishes flow communication with the flow channel. The system also includes an electric contact disposed on an exterior portion of the housing.

In certain configurations, the system also includes a centrifuge having a receiving port adapted to receive the blood collection device. The electric contact of the biological fluid collection device is engaged with a corresponding portion of the centrifuge. The flow channel may be a serpentine flow channel. In some configurations, the biological fluid collection device is only receivable within the centrifuge in one orientation. When the blood collection device is received within the centrifuge and a rotational force applied to the blood collection device, the plasma portion of the blood sample may be separated from the cellular portion through the flow channel.

### BRIEF DESCRIPTION OF THE DRAWINGS

The above-mentioned and other features and advantages of this disclosure, and the manner of attaining them, will become more apparent and the disclosure itself will be better understood by reference to the following descriptions of embodiments of the disclosure taken in conjunction with the accompanying drawings, wherein:

FIG. 1 is a perspective view of a biological fluid collection device in accordance with an embodiment of the present invention.

FIG. 2 is an elevation view of a biological fluid collection device in accordance with an embodiment of the present invention.

FIG. 3 is a perspective view of a biological fluid collection device secured to a patient in accordance with an embodiment of the present invention.

FIG. 4 is a perspective view of a biological fluid separation system in accordance with an embodiment of the present invention.

FIG. 5 is an elevation view of a blood separation device in accordance with an embodiment of the present invention.

FIG. 6 is an elevation view of a blood separation device in accordance with an embodiment of the present invention, with a biological fluid collection device received within a receiving port of the blood separation device.

FIG. 7 is a partial cross-sectional view of a biological fluid collection device in accordance with an embodiment of the present invention.

FIG. 8 is a cross-sectional view of the biological fluid collection device of FIG. 3 in accordance with an embodiment of the present invention, with a puncturing element in a puncturing position.

FIG. 9 is a cross-sectional view of the biological fluid collection device of FIG. 3 with a blood sample received within the biological fluid collection device in accordance with an embodiment of the present invention, with a puncturing element in a pre-actuation position.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

Various point-of-care testing devices are known in the art. Such point-of-care testing devices include test strips, glass slides, diagnostic cartridges, or other testing devices for testing and analysis. Test strips, glass slides, and diagnostic cartridges are point-of-care testing devices that receive a blood sample and test that blood for one or more physiological and biochemical states. There are many point-of-care devices that use cartridge based architecture to analyze very small amounts of blood bedside without the need to send the sample to a lab for analysis. This saves time in getting results over the long run but creates a different set of challenges versus the highly routine lab environment. Examples of such testing cartridges include the i-STAT® testing cartridge from the Abbot group of companies. Testing cartridges such as the i-STAT® cartridges may be used to test for a variety of conditions including the presence of chemicals and electrolytes, hematology, blood gas concentrations, coagulation, or cardiac markers. The results of tests using such cartridges are quickly provided to the clinician.

However, the samples provided to such point-of-care testing cartridges are currently manually collected with an open system and transferred to the point-of-care testing cartridge in a manual manner that often leads to inconsistent results, or failure of the cartridge leading to a repeat of the sample collection and testing process, thereby negating the advantage of the point-of-care testing device. Accordingly, a need exists for a system for collecting, transferring, and testing a sample that provides safer, reproducible, and more accurate results.

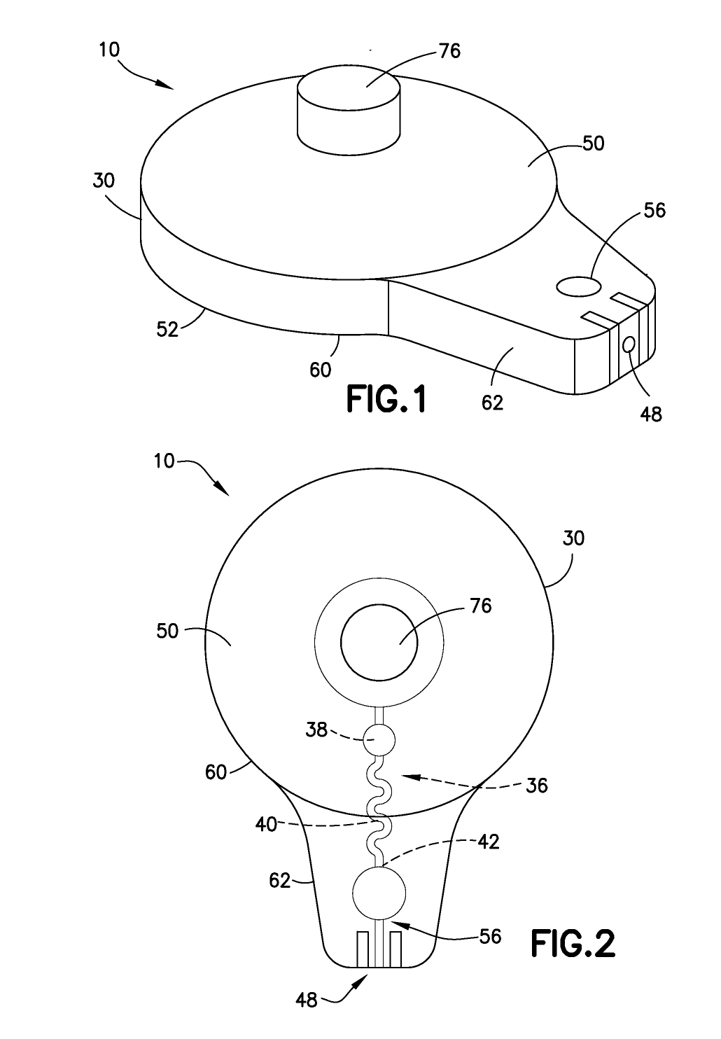

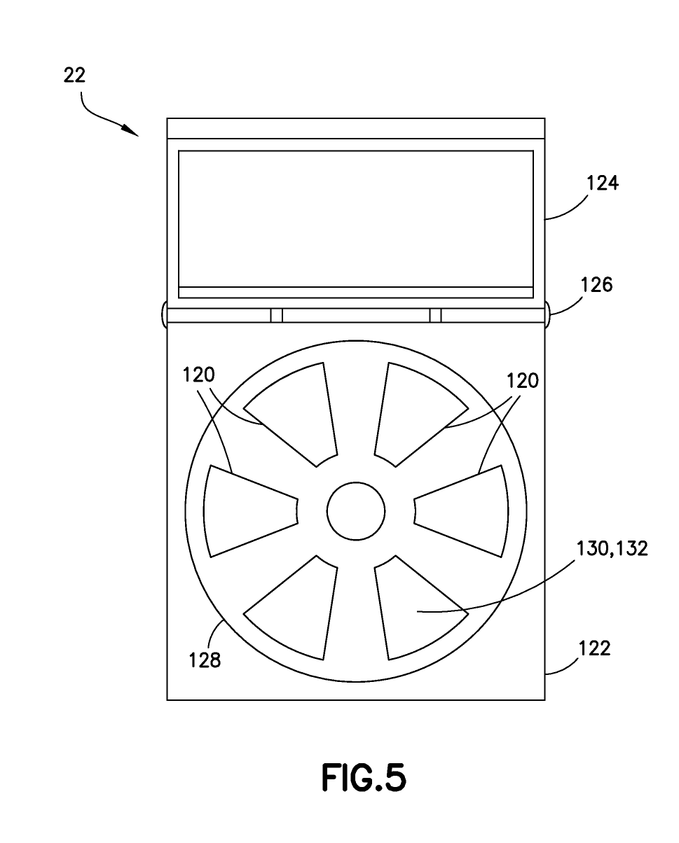

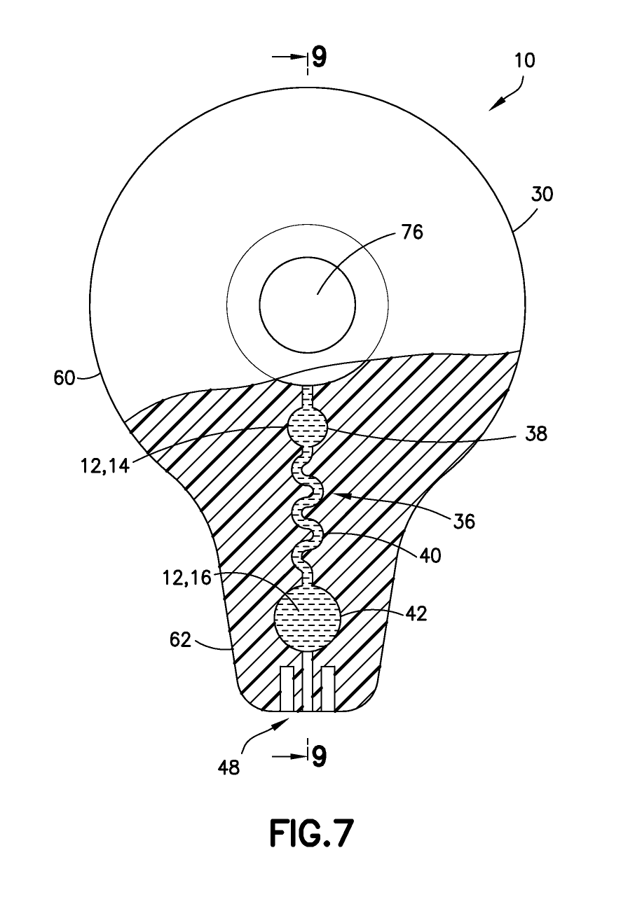

FIGS. 1-9 illustrate an exemplary embodiment of the present disclosure. A biological fluid collection device, such as a blood collection device 10, of the present disclosure incorporates the concepts of lancing, blood collection, and blood separation. Referring to FIGS. 1-9, a blood collection device 10 of the present disclosure is adapted to receive a blood sample 12 having a cellular portion 14 and a plasma portion 16.

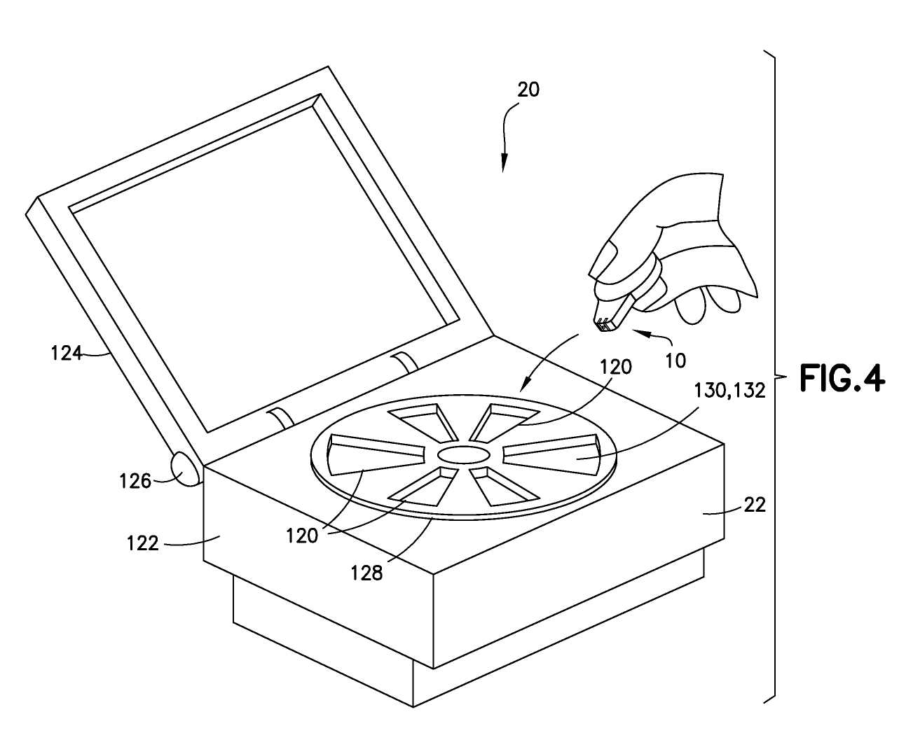

FIGS. 4-6 illustrate an exemplary embodiment of the present disclosure. Referring to FIGS. 4-6, a biological fluid separation system, such as a blood separation system 20 of the present disclosure for a blood sample 12 includes a blood collection device 10 adapted to receive a blood sample 12 and a blood separation device or centrifuge 22. The centrifuge 22 is adapted to receive the blood collection device 10 such that with the blood collection device 10 received within the centrifuge 22 and a rotational force applied to the blood collection device 10, a plasma portion 16 of the blood sample 12 is separated from a cellular portion 14 of the blood sample 12. The separated blood can then be analyzed by the centrifuge 22 without removing the blood collection device 10 from the centrifuge 22. For example, a blood separation system of the present disclosure may be used to determine a hematocrit value by centrifugation. The centrifuge 22 may be connected to a computer system and the results of the analysis can be viewed on a display screen of the computer system or sent wirelessly to a hand-held electronic device.

Some of the advantages of the blood collection device and the biological fluid separation system of the present disclosure over prior systems are that it is a closed system which reduces blood sample exposure and it provides passive and fast mixing of the blood sample with a sample stabilizer. Also, a biological fluid sampling transfer device of the present disclosure incorporates the concepts of lancing, blood collection, and blood separation.

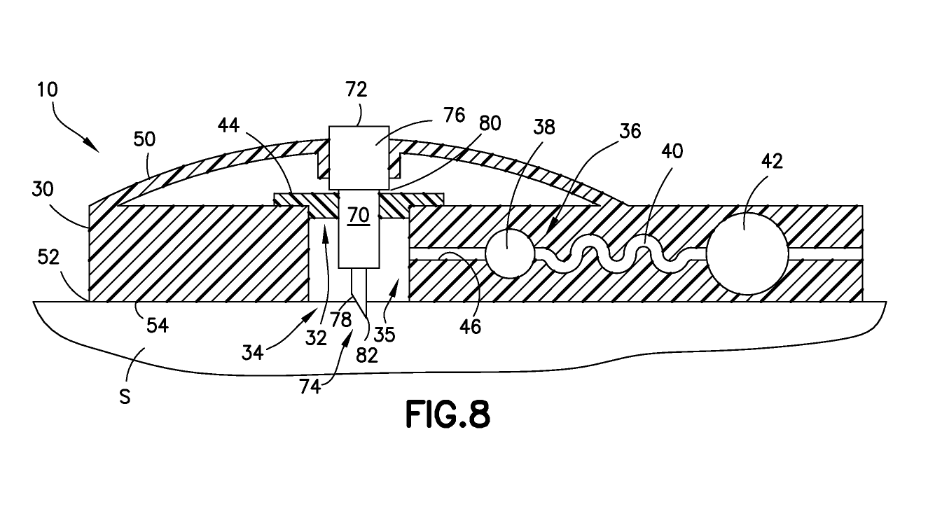

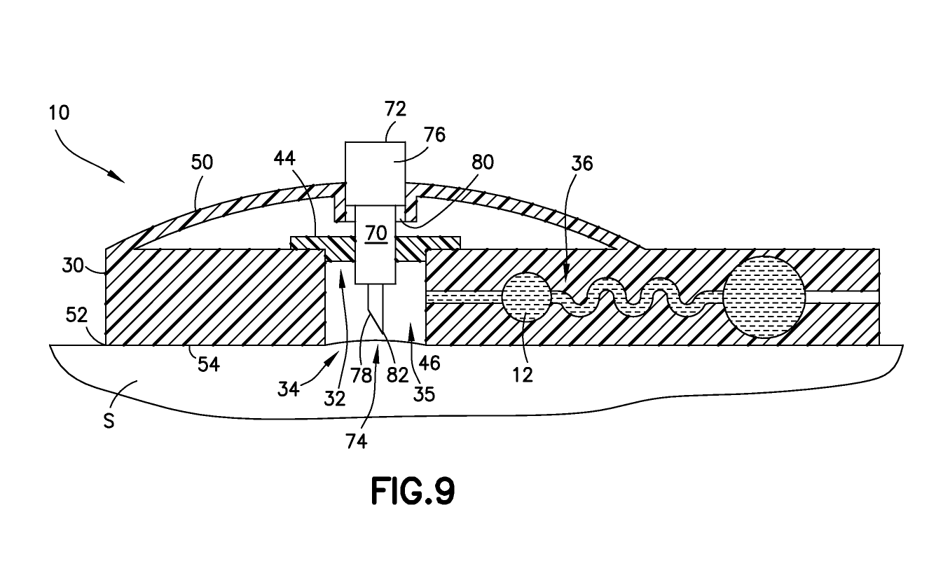

Referring to FIGS. 1-9, the blood collection device 10 generally includes a housing 30 defining a central aperture 32 therethrough, an inlet port 34, an inlet flow channel 35, a flow channel 36 in fluid communication with the inlet port 34, a first reservoir 38 in fluid communication with the inlet port 34, a serpentine flow channel 40 in fluid communication with the first reservoir 38, a second reservoir 42 in fluid communication with the serpentine flow channel 40, a puncturing element engagement portion 44, a sample stabilizer 46, an electric contact 48, and an indicator element 56. Referring to FIGS. 8 and 9, the blood collection device 10 includes a puncturing element structure 70 that is positioned within the central aperture 32 of the housing 30. The housing 30 includes a puncturing element engagement portion 44 for securing the puncturing element structure 70 within the central aperture 32 of the housing 30. In one embodiment, the inlet flow channel 35 is in fluid communication with the serpentine flow channel 40 and the inlet flow channel 35 is oriented in a plane that is offset from a plane defining a flow axis of the serpentine channel 40. In one embodiment, the housing 30 of the blood collection device 10 includes the electric contact 48 for engagement with a corresponding electric contact of the centrifuge 22. In one embodiment, a portion of the housing 30 of the blood collection device 10 is transparent. For example, a portion of the housing 30 is transparent to allow a user to be able to see the cellular portion 14 and the plasma portion 16 within the reservoirs 38, 42 and the flow channels 36, 40.

The blood collection device 10 is adapted to receive a blood sample 12 having a cellular portion 14 and a plasma portion 16. In one embodiment, the indicator element 56 is transitionable between an initial setting and a complete setting and the indicator element 56 automatically transitions to the complete setting when collection of the blood sample 12 within the blood collection device 10 is complete.

The blood collection device 10 is adapted to contain a sample stabilizer 46 to provide passive and fast mixing of a blood sample with the sample stabilizer 46. The sample stabilizer 46 can be an anticoagulant, or a substance designed to preserve a specific element within the blood such as, for example, RNA, protein analyte, or other element. In one embodiment, the sample stabilizer 46 is provided within a portion of the flow channel 36. In other embodiments, the sample stabilizer 46 is provided in other areas of the housing 30 such as the inlet port 34 or the first reservoir 38.

In one embodiment, a portion of the flow channel 36 comprises a serpentine shape to promote efficient mixing and separation of a blood sample 12 having a cellular portion 14 and a plasma portion 16. As discussed below, a centrifuge 22 provides a rotational force applied to the blood collection device 10 to separate the plasma portion 16 from the cellular portion 14 through the flow channel 36. In other embodiments, the flow channel 36 comprises other shapes to promote efficient mixing and separation of a blood sample.

The upper portion of the housing 30 includes a dome-shaped surface 50 and the lower portion of the housing 30 includes a bottom surface 52. Referring to FIGS. 8 and 9, the bottom surface 52 includes an adhesive 54 so that the blood collection device 10 can be secured onto a skin surface S of a patient where a blood sample will be accessed. In one embodiment, the adhesive 54 of the bottom surface 52 is protected by a peel-off layer, similar to an adhesive bandage, which would be removed before placing the blood collection device 10 on the skin surface S of the patient's body. A hydrogel or other layer could be included to provide some thickness to the bottom surface 52 and help improve the stability of the adhesive seal. Additionally, in one embodiment, the adhesive 54 could include a chemistry to create a more liquid-tight seal, similar to painter's tape technology, where wetting from the paint itself causes a chemical reaction with the adhesive 54 to create a more water-tight barrier to prevent the paint from seeping under the tape.

Referring to FIGS. 1-9, the blood collection device 10 also includes a puncturing element structure 70 that may be secured within the central aperture 32 of the housing 30. The puncturing element structure 70 generally includes a first end 72, a second end 74, a push button 76 adjacent the first end 72, a puncturing element 78 adjacent the second end 74, and a housing engagement portion 80. The housing engagement portion 80 engages the puncturing element engagement portion 44 of the housing 30 for securing the puncturing element structure 70 to the housing 30 within the central aperture 32 as shown in FIGS. 8 and 9. The puncturing element structure 70 includes a puncturing element 78 having a puncturing end 82. The puncturing end 82 is adapted for puncturing the skin surface S of a patient (FIG. 8), and may define a pointed end, a blade edge, or a similar cutting mechanism. The puncturing end 82 may include a preferred alignment orientation, such as with a pointed end of a blade aligned in a specific orientation. In one embodiment, the puncturing element 78 comprises a micro-needle array.

The puncturing element 78 is adapted for movement between a pre-actuated position (FIG. 9) wherein the puncturing element 78 including the puncturing end 82 is retained within the housing 30 and a puncturing position (FIG. 8) wherein the puncturing end 82 of the puncturing element 78 extends through the inlet port 34 of the housing 30 to puncture a skin surface S of a patient to draw a blood sample and to establish flow communication with the flow channel 36. In one embodiment, actuation of the push button 76 moves the puncturing element 78 from the pre-actuated position (FIG. 9) to the puncturing position (FIG. 8).

In one embodiment, with the puncturing element 78 in the puncturing position, the blood collection device 10 is adapted to generate a vacuum in communication with the inlet port 34 of the housing 30 of the blood collection device 10 to assist in pulling the blood sample 12 within the blood collection device 10.

In one embodiment, the housing 30 of the blood collection device 10 may include a self-sealing dock that would allow an external lancet or puncturing element to be removably received within the housing 30. The external lancet or puncturing element could be either pre-integrated into the packaged blood collection device 10 or introduced separately by a user before using the blood collection device 10 of the present disclosure.

Referring to FIGS. 4-6, a blood separation system 20 of the present disclosure for a blood sample 12 includes a blood collection device 10 adapted to receive a blood sample 12 and a blood separation device or centrifuge 22. The centrifuge 22 is adapted to receive the blood collection device 10 such that with the blood collection device 10 received within the centrifuge 22 and a rotational force applied to the blood collection device 10, a plasma portion 16 of the blood sample 12 is separated from a cellular portion 14 of the blood sample 12. The separated blood can then be analyzed by the centrifuge 22 without removing the blood collection device 10 from the centrifuge 22. The centrifuge 22 may be connected to a computer system and the results of the analysis can be viewed on a display screen of the computer system or sent wirelessly to a hand-held electronic device.

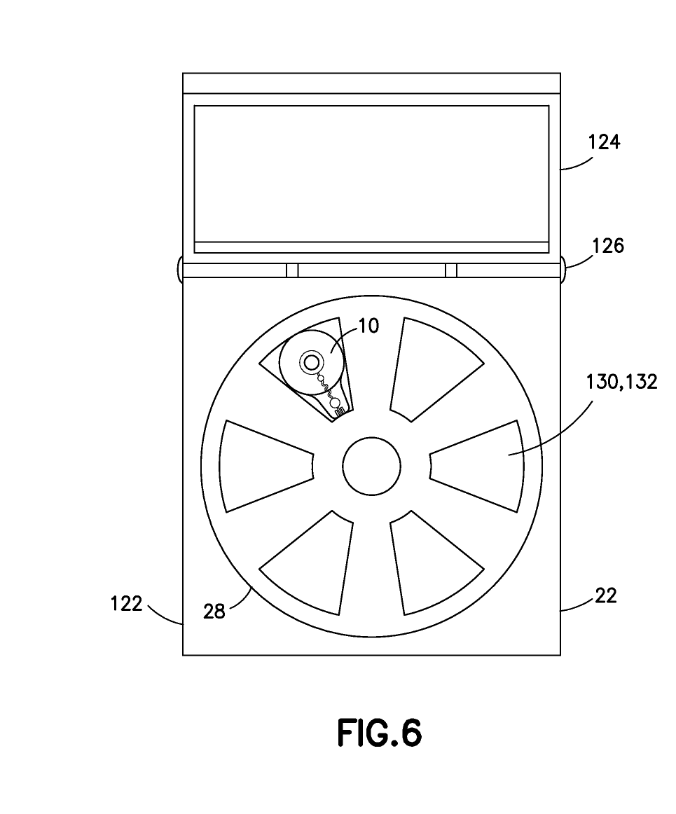

Referring to FIGS. 4-6, a blood separation device or centrifuge 22 of the present disclosure generally includes a receiving port 120 adapted to receive the blood collection device 10 such that with the blood collection device 10 received within the centrifuge 22 and a rotational force applied to the blood collection device 10, a plasma portion 16 of the blood sample 12 is separated from a cellular portion 14 of the blood sample 12. The centrifuge 22 includes a receiving port 120 adapted to receive the blood collection device 10, a base or bottom portion 122, a top portion 124 movably connected to the base portion 122 by a hinged portion 126, and a rotational force element 128 contained within the base portion 122. The top portion 124 is transitionable between an open position in which the blood collection device 10 can be placed within the receiving port 120 as shown in FIG. 6 and a closed position. With the blood collection device 10 received within the centrifuge 22, a rotational force is applied to the blood collection device 10 to separate the plasma portion 16 from the cellular portion 14.

Referring to FIG. 4, in one embodiment, the centrifuge 22 includes a plurality of receiving ports 120 each adapted to receive a separate blood collection device 10. In this manner, the blood separation system 20 of the present disclosure can receive, separate, and analyze a plurality of blood collection devices 10.

Referring to FIGS. 1-6, a blood collection device 10 of the present disclosure is only receivable within a receiving port 120 of the centrifuge 22 in one orientation. In one embodiment, the housing 30 of the blood collection device 10 has an exterior profile 60 including a key portion 62. The receiving port 120 of the centrifuge 22 defines an interior profile 130 including a keyway portion 132. The exterior profile 60 and the key portion 62 of the blood collection device 10 are sized and shaped to substantially correspond to the interior profile 130 and the keyway portion 132 of the receiving port 120 of the centrifuge 22 such that the blood collection device 10 is only receivable within the receiving port 120 of the centrifuge 22 in one orientation. In this manner, the blood collection device 10 can only be inserted into the receiving port 120 of the centrifuge 22 in one way to ensure that the electric contact 48 provided on the blood collection device 10 is placed properly and is engaged with a corresponding portion of the centrifuge 22.

The exterior profile 60 and the key portion 62 of the blood collection device 10 and the interior profile 130 and the keyway portion 132 of the receiving port 120 of the centrifuge 22 can have any shape that provides a key portion and a keyway portion that only allow the blood collection device 10 to be received within the receiving port 120 of the centrifuge 22 in one orientation.

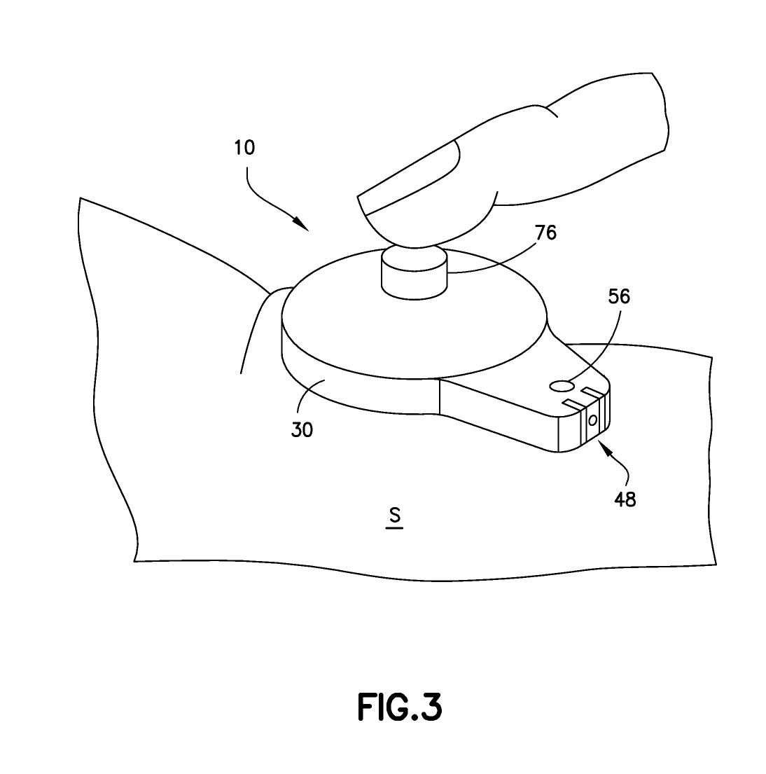

Referring to FIGS. 1-9, use of a blood collection device of the present disclosure will now be described. Referring to FIGS. 3 and 9, upon selecting a site, a clinician can adhere the adhesive 54 on the bottom surface 52 of the housing 30 onto a skin surface S of a patient where a blood sample will be accessed over a selected sampling site.

Next, the push button 76 on the blood collection device 10 is depressed or actuated to move the puncturing element 78 from the pre-actuated position (FIG. 9) to the puncturing position (FIG. 8) so that the puncturing element 78 punctures the skin surface S of a patient. In one embodiment, a vacuum is applied simultaneously. Thereafter, a blood sample 12 is drawn into a microfluidic flow channel 36 via capillary action. The blood sample is exposed to and mixed with a sample stabilizer 46 in the flow channel 36. The sample stabilizer 46 can be an anticoagulant, or a substance designed to preserve a specific element within the blood such as, for example, RNA, protein analyte, or other element.

When the indicator element 56 turns to a complete setting or a specific color such as red, indicating that collection of the blood sample 12 has been completed, the user removes the blood collection device 10 from the patient's arm.

Referring to FIGS. 4-6, the next step of the process involves manual insertion of the blood collection device 10 into a blood separation device or centrifuge 22 designed specifically for the blood collection device 10. For example, the blood collection device 10 is transferred to a “spin chip” blood separation device or centrifuge 22 that acts as a miniaturized smart blood separation device. The blood collection device 10 can only be inserted into the receiving port 120 of the centrifuge 22 in one way to ensure that the electric contact 48 provided on the blood collection device 10 is placed properly and is engaged with a corresponding portion of the centrifuge 22.

The centrifuge 22 is designed to facilitate plasma separation by centrifugal force and to drive a blood sample through the flow channel 36 of the blood collection device 10. The blood sample 12 contained within the blood collection device 10 is quickly spun in the centrifuge 22 and due to the low volume is separated through the flow channel 36 of the blood collection device 10 within a few seconds such that the plasma portion 16 is collected within the second reservoir 42 of the blood collection device 10.

In one embodiment, the centrifuge 22 is adapted to receive the blood collection device 10 such that with the blood collection device 10 received within the centrifuge 22 and a rotational force applied to the blood collection device 10, a plasma portion 16 of the blood sample 12 is separated from a cellular portion 14 of the blood sample 12. The separated blood can then be analyzed by the centrifuge 22 without removing the blood collection device 10 from the centrifuge 22. The centrifuge 22 may be connected to a computer system and the results of the analysis can be viewed on a display screen of the computer system or sent wirelessly to a hand-held electronic device.

Some of the advantages of the blood collection device and the blood separation system of the present disclosure over prior systems are that it is a closed system which reduces blood sample exposure and it provides passive and fast mixing of the blood sample with a sample stabilizer. Also, the blood sampling transfer device of the present disclosure incorporates the concepts of lancing, blood collection, and blood separation.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A biological fluid collection device, comprising:
a housing having an inlet port and a serpentine flow channel in fluid communication with the inlet port; and
a puncturing element disposed within the housing and adapted for movement between a pre-actuated position wherein the puncturing element is retained within the housing and a puncturing position wherein the puncturing element extends through the inlet port of the housing and establishes flow communication with the serpentine flow channel.

2. The biological fluid collection device of claim 1, wherein with the puncturing element in the puncturing position, the biological fluid collection device is adapted to generate a vacuum in communication with the inlet port.

3. The biological fluid collection device of claim 1, further comprising a second flow channel in fluid communication with the serpentine flow channel, the second flow channel oriented in a plane that is offset from a plane defining a flow axis of the serpentine flow channel.

4. The biological fluid collection device of claim 1, wherein the biological fluid collection device is adapted to receive a multi-component blood sample having a cellular portion and a plasma portion.

5. The biological fluid collection device of claim 4, wherein when a rotational force is applied to the biological fluid collection device, the plasma portion is separated from the cellular portion through the serpentine flow channel.

6. The biological fluid collection device of claim 4, further comprising an indicator element transitionable between an initial setting and a complete setting, wherein the indicator element automatically transitions to the complete setting when collection of the blood sample is complete.

7. The biological fluid collection device of claim 1, wherein the puncturing element comprises a micro-needle array.

8. The biological fluid collection device of claim 1, wherein the housing includes a push button, wherein actuation of the push button moves the puncturing element from the pre-actuated position to the puncturing position.

9. The biological fluid collection device of claim 1, wherein at least a portion of the serpentine flow channel comprises a sample stabilizer.

10. The biological fluid collection device of claim 1, wherein the housing includes an electric contact for engagement with a corresponding electric contact of a centrifuge.

11. A biological fluid separation system for a blood sample having a cellular portion and a plasma portion, comprising:
a biological fluid collection device adapted to receive the blood sample, the biological fluid collection device comprising:
a housing having an inlet port and a flow channel in fluid communication with the inlet port;
a puncturing element disposed within the housing and adapted for movement between a pre-actuated position wherein the puncturing element is retained within the housing and a puncturing position wherein the puncturing element extends through the inlet port of the housing and establishes flow communication with the flow channel; and
an electric contact disposed on an exterior portion of the housing.

12. The biological fluid separation system of claim 11, further comprising a centrifuge having a receiving port adapted to receive the biological fluid collection device, wherein the electric contact of the biological fluid collection device is engaged with a corresponding portion of the centrifuge.

13. The biological fluid separation system of claim 11, wherein the flow channel is a serpentine flow channel.

14. The biological fluid separation system of claim 11, wherein the biological fluid collection device is only receivable within the centrifuge in one orientation.

15. The biological fluid separation system of claim 11, wherein with the biological fluid collection device received within the centrifuge and a rotational force applied to the biological fluid collection device, the plasma portion of the blood sample is separated from the cellular portion through the flow channel.
